(19) United States
(12) Patent Application Publication
(10) Pub. No.: US 2016/0156875 A1
(43) Pub. Date: Jun. 2, 2016

(54) COMMUNICATION METHOD AND COMMUNICATION DEVICE USING SAME

(71) Applicants: HON HAI PRECISION INDUSTRY CO., LTD., New Taipei (TW); Fu Tai Hua Industry (Shenzhen) Co., Ltd., Shenzhen (CN)

(72) Inventor: XUE-QIN ZHANG, Shenzhen (CN)

(21) Appl. No.: 14/951,627

(22) Filed: Nov. 25, 2015

(30) Foreign Application Priority Data
Nov. 28, 2014 (CN) 201410712073.3

(51) Int. Cl. H04N 7/14; H04N 5/262; H04N 5/265; H04N 5/33

(52) U.S. Cl. CPC H04N 7/147; H04N 5/33; H04N 5/2628; H04N 5/265

(57) ABSTRACT

A communication method is provided. The method includes: receiving, at a communication device, a first video frame of a communicating party which is in a communication with the communication device; obtaining, at the communication device, a second video frame of the local party through a camera; identifying, at the communication device, an outline of a user in the second video frame; cropping, at the communication device, a part of the second video frame beside the outline of the user to generate a third video frame which includes only images inside the outline of the user; combining, at the communication device, the third video frame with the first video frame of the communicating party to generate a fourth video frame; and displaying, at the communication device, the fourth video frame.

### FIELD

The subject matter herein generally relates to a visual communication device and a communication method thereof and, in particular, to a motion sensing visual communication system and method.

### BACKGROUND

Along with developments of the third generation wireless communication technology, a series of data services based on high broadband are raised rapidly. Most representatives of those data services can include mobile multimedia broadcasting (also named as mobile television) and video phones. The video phones facilitate a point to point visual communication services which can bidirectionally transmit images and voices of two parties involved in the visual communication services.

### BRIEF DESCRIPTION OF THE DRAWINGS

Implementations of the present technology will now be described, by way of example only, with reference to the attached figures.

FIG. 1 is a block diagram of a first exemplary embodiment of a communication device.

FIG. 2 is a block diagram of a second exemplary embodiment of a communication device.

FIG. 3 is a diagrammatic view of an exemplary embodiment of a display device.

FIG. 4 is a block diagram of an exemplary embodiment of a visual communication system.

FIG. 5 is a flow chart of an exemplary embodiment of a visual communication method.

FIG. 6 is a diagrammatic view of a video frame of a first party.

FIG. 7 is a diagrammatic view of a video frame received from a second party.

FIG. 8 is a diagrammatic view of a video frame by combining the video frame of the first party with the received video frame.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Definitions that apply throughout this disclosure will now be presented.

The term “exemplary” refers to a non-limiting example. The term “comprising,” when utilized, means “including, but not necessarily limited to”; it specifically indicates open-ended inclusion or membership in the so-described combination, group, series and the like.

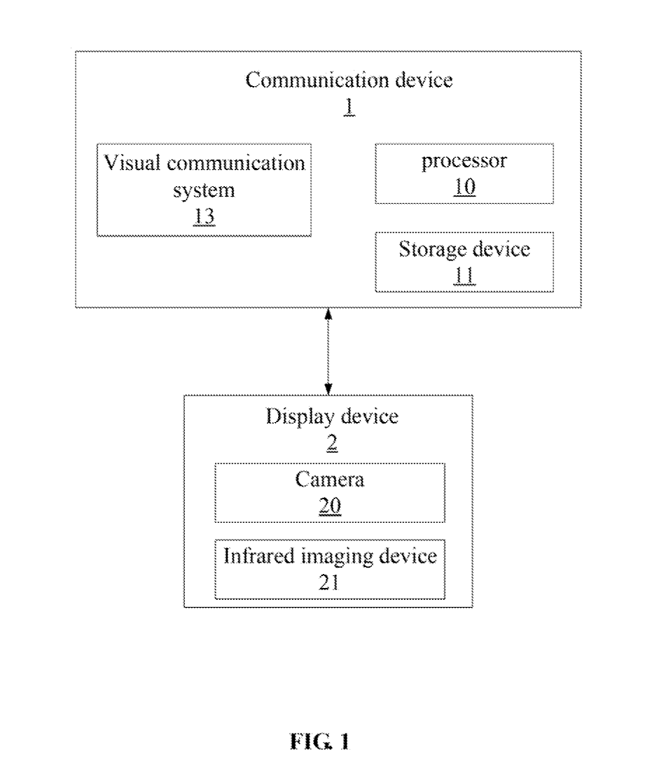

FIG. 1 illustrates a block diagram of a first exemplary embodiment of a communication device 1. In the exemplary embodiment, the communication device 1 can be a traditional communication device, for example, a fixed phone or a wireless fixed phone. The communication device 1 can be coupled to an outside display device, for example, a computer screen or a liquid crystal display (LCD) television (TV).

The communication device 1 can include, but is not limited to, a processor 10 and a storage device 11. The processor 10 can be a central processing unit (CPU), a microprocessor, or other data processor chip that performs functions of the communication device 1. The storage device 11 can be an internal storage unit of the communication device 1, for example, a hard disk or memory, or a pluggable memory, for example, Smart Media Card, Secure Digital Card, Flash Card. In at least one embodiment, the storage device 11 can include two or more storage devices such that one storage device is an internal storage unit and the other storage device is a removable memory.

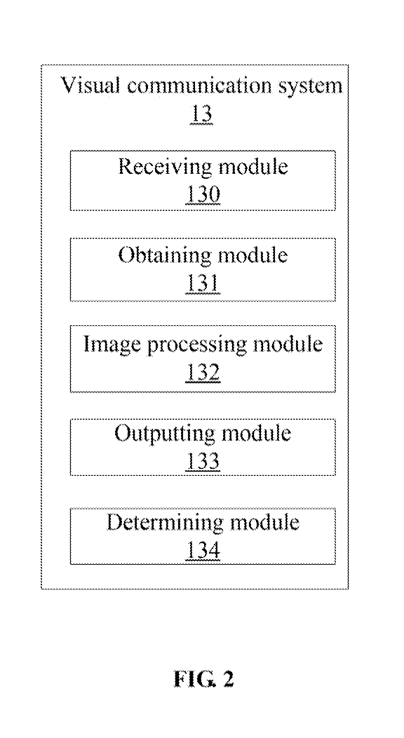

A visual communication system 13 can include computerized instructions in the form of one or more programs that can be executed by the processor 10. In the embodiment, the visual communication system 13 can be integrated in the processor 10. In at least one embodiment, the visual communication system 13 can be independent from the processor 10 and can be stored in the storage device 11 and coupled to the processor 10. An exemplary detailed block diagram of the visual communication system 13 is illustrated in FIG. 2.

The visual communication system 13 can include one or more modules, for example, a receiving module 130, an obtaining module 131, an image processing module 132, an outputting module 133, and a determining module 134. A “module,” as used herein, refers to logic embodied in hardware or firmware, or to a collection of software instructions, written in a programming language, such as, JAVA, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

The receiving module 130 can be configured to receive a first video frame from a second party. In at least one exemplary embodiment, the communication device 1 can communicate with a second party and the communication device 1 is referred as to the first party. In general, the first party and the second party can be located in different positions so that the first party and the second party cannot see each other. The first video frame can include an image of a user of the second party and an image of surroundings around the user. The image of the user can have an outline. The image of the surroundings can be referred as to the part outside the outline of the user. In at least one embodiment, the first video frame can only include an image inside the outline of the user of the second party.

The obtaining module 131 can be configured to capture a second video frame of the first party using a camera and capture a third video frame of the first party using an infrared imaging device.

The image processing module 132 can be configured to identify a user in the second video frame, and to crop the part of the second video frame which is outside an outline of the user to generate a fourth video frame. The image processing module 132 further can be configured to combine the fourth video frame with the first video frame to generate a fifth video frame. The third video frame can be used to identify a user in the third video frame and determine a position of the user in the third video frame based on which the position of the user in the second video frame can be determined. Therefore, the image processing module 132 can be configured to identify the user in the second video frame based on the position of the user in the second video frame.

The outputting module 133 can be configured to output the fifth video frame. In at least one embodiment, the outputting module 133 can be configured to output the fifth video frame to the display device 2 to display the fifth video frame on the display device 2. In at least one embodiment, the outputting module 133 can be configured to output the fifth video frame to the second party through a communication network based on which the communication between the first party and the second party is established. The communication network can include, but is not limited to, Public Switched Telephone Network (PSTN), Voice over Internet Protocol (VOIP), or mobile telecommunication networks.

The determining module 134 can be configured to determine whether the communication between the first party and the second party is finished.

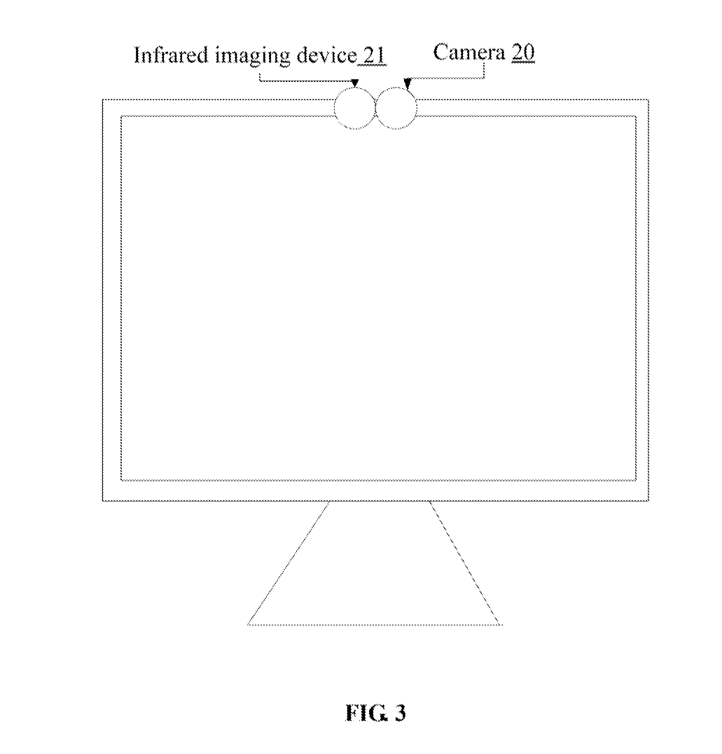

The display device 2 can be in a size which is nearly as high as an adult, for example, 1.5-2.0 meters in height, and 1.2-1.5 meters in width. In at least one embodiment, the display device 2 can be in any suitable size, for example, 32 inches, 42 inches, 50 inches, 55 inches or 60 inches. An exemplary embodiment of the display device 2 is illustrated in FIG. 3. The display device 2 can be equipped with a camera 20 and an infrared imaging device 21 at the top front of the display device 2. In at least one embodiment, the camera 20 and the infrared imaging device 21 can be positioned at a center of the top front of the display device 2.

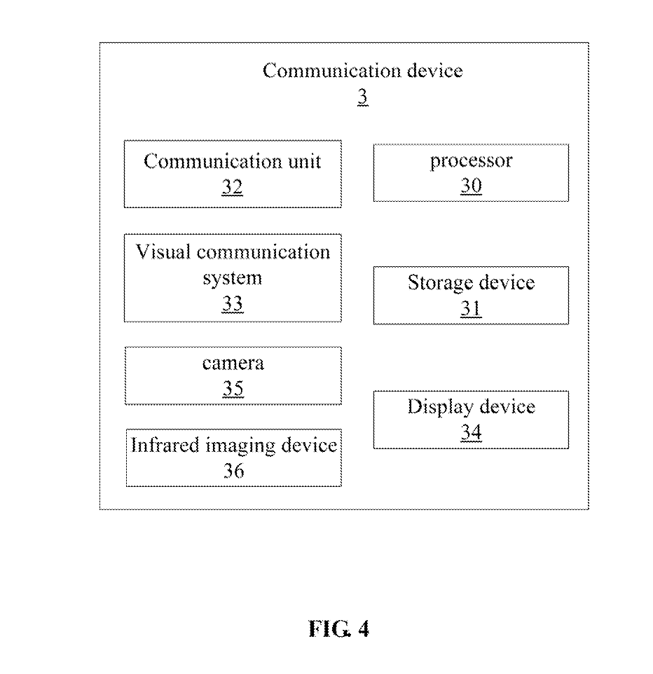

FIG. 4 illustrates a block diagram of a second exemplary embodiment of a communication device 3. In the exemplary embodiment, the communication device 3 can be an electronic device equipped with a communication unit 32, for example, an all-in-one personal computer (PC), a desktop computer, or a smart TV. The communication unit 32 can include an instant communication system, for example, SKYPE®, or QQ®.

The communication device 3 further can include a processor 30, a storage device 31 and a display device 34. The processor 30 can be a central processing unit (CPU), a microprocessor, or other data processor chip that performs functions of the communication device 3. The storage device 31 can be an internal storage unit of the communication device 3, for example, a hard disk or memory, or a pluggable memory, for example, Smart Media Card, Secure Digital Card, or Flash Card. In at least one embodiment, the storage device 31 can include two or more storage devices such that one storage device is an internal storage unit and the other storage device is a removable memory.

A visual communication system 33 can include computerized instructions in the form of one or more programs that can be executed by the processor 30. The visual communication system 33 is fundamentally the same as the visual communication system 13, and any element of the visual communication system 33 not specifically described herein can be assumed to be the same as in the visual communication system 13.

Similarly, the display device 34 can be fundamentally the same as the display device 2, and any element of the display device 34 not specifically described herein can be assumed to be the same as in the display device 2. Similar to the display device 2, a camera 35 and an infrared imaging device 36 can be equipped on the display device 34.

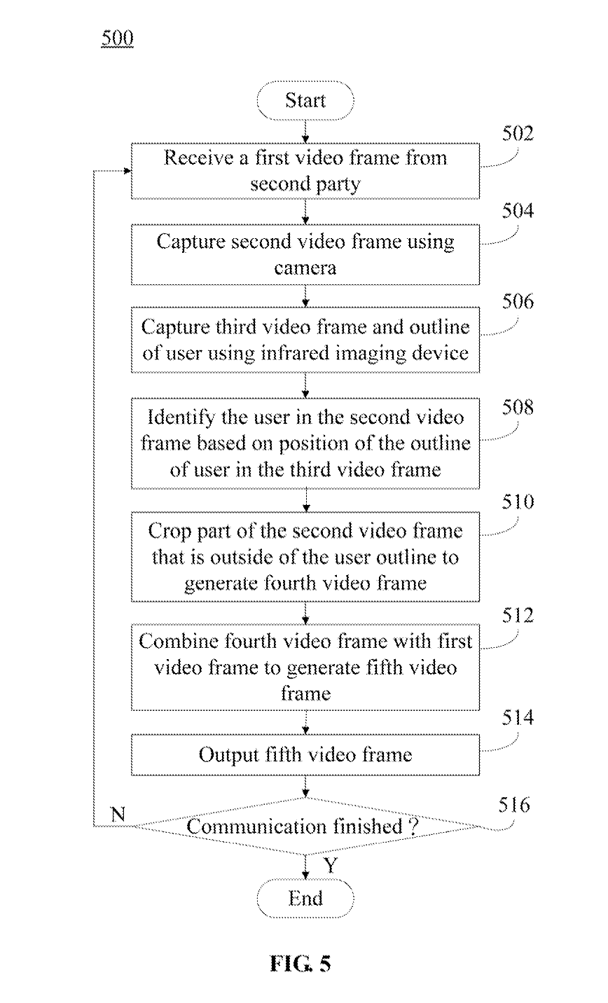

FIG. 5 illustrates a flowchart of an exemplary embodiment of a visual communication method 500 performed by a communication device. The example method 500 is provided by way of example, as there are a variety of ways to carry out the method. The method 500 described below can be carried out using the configurations illustrated in FIGS. 1-4, for example, and various elements of the figures are referenced in explaining example method 500. Each block shown in FIG. 5 represents one or more processes, methods or subroutines, carried out in the exemplary method 500. Furthermore, the illustrated order of blocks is by example only and the order of the blocks can change according to the present disclosure. Additional blocks may be added or fewer blocks may be utilized, without departing from this disclosure. The communication device can include a camera and an infrared imaging device. The exemplary method 500 can begin at block 502.

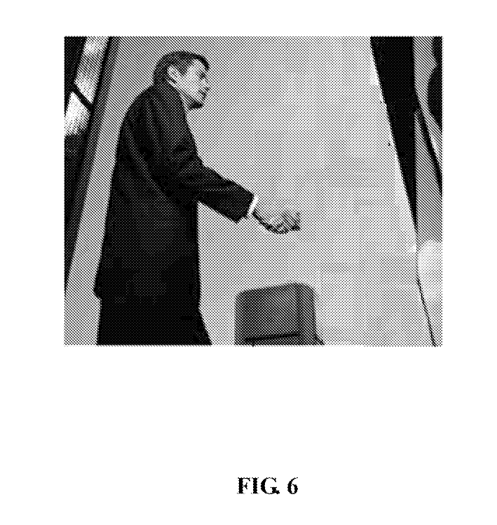

At block 502, the communication device receives a first video frame, for example, an image illustrated in FIG. 6, from a second party which is in a communication with the communication device upon the communication is established. The communication device can be referred as to a first party. The first party or the second party can include at least one user. In at least one embodiment, the communication between the first party and the second party can be established by dialing-up connection. The communication between the first party and the second party can be based on PSTN, VOIP, or mobile telecommunication networks. The first video frame can include an image of the user, for example user B, in the second party and an image of surroundings involved the second party.

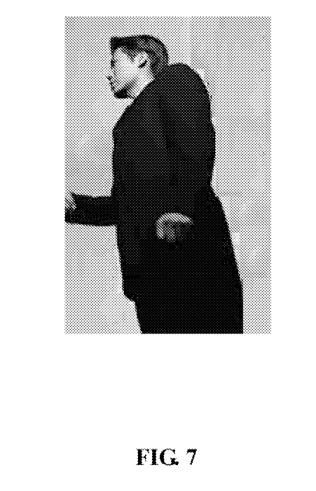

At block 504, the communication device captures a second video frame, for example, as illustrated in FIG. 7, using the camera. The second video frame can include an image of the user, for example, user A, in the first party and an image of surroundings involved the first party.

At block 506, the communication device captures a third video frame using the infrared imaging device and identifies an outline of the user, for example user A, in the third video frame. The infrared imaging device adopts a thermal imaging technology which detects near-infrared radiation of an object and converts the radiation to images. The user can be identified in the third video frame because the radiation of the user is different from the surroundings. In at least one exemplary embodiment, parameters of the infrared imaging device can be set to be same with that of the camera so that the image of the user in the second video frame can be in a substantially same position with that in the third video frame. Block 41 and block 42 can be concurrent. In at least one embodiment, block 41 and block 42 can occur at different time, for example, block 41 occurs following block 42 or block 42 occurs following block 41.

At block 508, the communication device identifies the outline of the user in the second video frame based on the position of the outline of the user in the third video frame. In at least one embodiment, the camera is close to the infrared imaging device and parameters of the camera is same with the infrared imaging device, and the position of the outline of the user in the second video frame is substantially same with that in the third video frame. Thus, the communication device can determine the position of the outline of the user in the second video frame based on the position of the outline of the user in the third video frame. In at least one embodiment, if the camera is apart from the infrared imaging device by a distance, the communication device can first determine the position of the outline of the user by combine the distance with the position of the outline of the user in the second video frame.

Alternatively or additionally, the communication device can obtain a corrected outline by image recognition technology, for example, boundary point identification technology. The identification technology can be performed based on change of pixel value of each point in the first video frame.

For example, the outline of the user in the second video frame may not cover clothing of the user. The clothing of the user can be identified by boundary point identification technology. In at least one embodiment, the boundary of the outline of the user can be identified by pixel values of points in the video frame. For example, if a plurality of points along a line have values as follow: a1=100, a2=102, a3=105, a4=102, a5=200, a6=199, a7=198, a9=200, a10=202, a11=200, a12=202, a13=198, a14=2, a15=3, a16=5, a17=2, a18=4, a19=3, a20=2, upon a condition that a6 is one of points in the outline of the user, a5 and a13 can be identified as points in the outline of the user.

At block 510, the communication device crops a part of the second video frame outside the outline of the user to generate a fourth video frame. The fourth video frame includes only images inside the outline of the user.

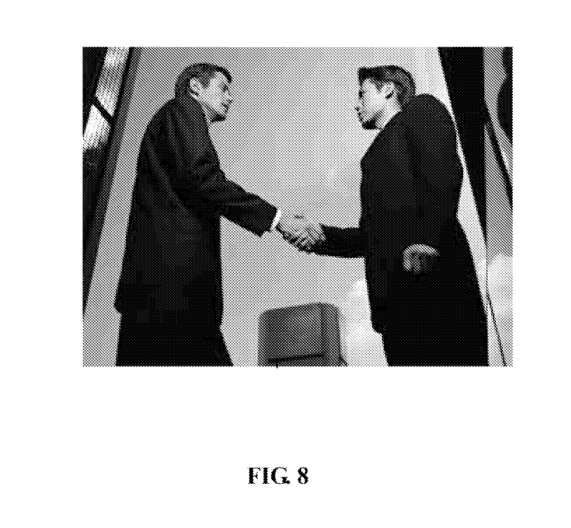

At block 512, the communication device combines the fourth video frame and the first video frame to generate a fifth video frame, for example, as illustrated in FIG. 8. Combination of the fourth video frame with the first video frame can be performed by any suitable image processing technology, for example, video synthesis technology, background transparency technology, soft edges technology. The background transparency technology can be used on overlap portions of two video frames, for example, the portion of the first video frame which is covered by the image of the user in the fourth video frame. The soft edges technology can be used to cause the outline of the user in the fourth video frame softer or less distinct.

At block 514, the communication device outputs the fifth video frame. The fifth video frame can be outputted to and displayed on a display device which is coupled with the communication device. In at least one exemplary embodiment, the fifth video frame can be transmitted to the second party though communication networks, for example, PSTN, VOIP, or mobile telecommunication networks.

At block 516, the communication device determines whether the communication between the first party and the second party is finished. If the communication is finished, the process goes to an end, otherwise, the process goes back to block 502. The determination can be made based on whether a user command indicating finishing the communication is received. The user command can be from a keyboard, touchpad, voice or motion of a user.

In at least one embodiment, the communication device can first receive a sixth video frame from the second party; secondly identify the outline of the user in the sixth video frame by image recognition technologies; thirdly crop the part of the sixth video frame outside the outline of the user to generate a seventh video frame; fourthly capture a eighth video frame of the first party; and finally combine the seventh video frame and the eighth video frame to generate a ninth video frame to be outputted. In at least one embodiment, if the sixth video frame include only the image inside an outline of the user in the sixth video frame, the communication device can directly combine the sixth video frame with the eighth video frame to generate a combined video frame to be outputted.

In at least one embodiment, the communication device can first receive a tenth video frame from the second party; secondly identify the outline of the user in the tenth video frame by image recognition technologies; thirdly crop the part of the tenth video frame outside the outline of the user to generate a eleventh video frame; fourthly capture a twelfth video frame of the first party; fifthly identify the outline of the user in the twelfth video frame; sixthly crop the part of the twelfth video frame outside the outline of the user to generate a thirteen video frame; and finally combine the eleventh video frame and the thirteen video frame to generate a fourteen video frame to be outputted. In at least one embodiment, the eleventh video frame and the thirteen video frame can be combined with a predefined background video frame to generate a fifteen video frame to be outputted. In at least one embodiment, if the tenth video frame includes only the image inside an outline of the user in the tenth video frame, the communication device can directly combine the tenth video frame with the thirteen video frame to generate a combined video frame to be outputted.

In at least one embodiment, upon a condition that there are more than two parties involved in a communication. Each party can transmit a video frame of local party to a predefined party, for example, the main party who is responsible for set up the communication. The predefined party can obtain video frames corresponding to each party which include only images inside the outline of the user by the aforementioned method and then combines the obtained video frames to generate a combined video frame to be outputted. In at least one embodiment, the video frame transmitted from each party to the main predefined party can include only the image inside the outline of the user in the video frame. Therefore, the predefined party can directly combine the video frames from other party with the video frame of the predefined party to generate a combined video frame to be outputted.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A communication method comprising:
receiving, at a communication device, a first video frame of a communicating party which is in a communication with the communication device;
obtaining, at the communication device, a second video frame of the local party through a camera;
identifying, at the communication device, an outline of a user in the second video frame;
cropping, at the communication device, a part of the second video frame beside the outline of the user to generate a third video frame which includes only images inside the outline of the user;
combining, at the communication device, the third video frame with the first video frame of the communicating party to generate a fourth video frame; and
displaying, at the communication device, the fourth video frame.

2. The method according to claim 1, further comprising:
obtaining, at the communication device, a fifth video frame of the local party through an infrared imaging device;
identifying, at the communication device, an outline of a user in the fifth video frame;
determining, at the communication device, a position where the outline of the user in the fifth video frame; and
identifying, at the communication device, an outline of a user in the second video frame based on the position where the outline of the user in the fifth video frame and a relationship between the camera and the infrared imaging device.

3. The method according to claim 1, further comprising:
determining, at the communication device, a corrected outline of the user in the second video frame by boundary point identification.

4. The method according to claim 3, wherein the boundary point identification is performed by:
obtaining, at the communication device, pixel values of each points in the second video frame; and
determining, at the communication device based on change of pixel values.

5. The method according to claim 1, further comprising:
transmitting, from the communication device, the fourth video frame to the communicating party.

6. The method according to claim 1, further comprising:
combing, at the communication device, the third video frame and the first video frame based on a video synthesis technology which includes background transparency and soft edges.

7. The method according to claim 1, wherein the first video frame includes only images inside an outline of a user in the first video frame.

8. The method according to claim 7, further comprising: combining, at the communication device, the first video frame and the third video frame with a predefined background video frame to generate a fifth video frame to be outputted.

9. A communication method, comprising:
receiving, at a communication device, at least one first video frame of at least one communicating party which is in a communication with the communication device, wherein each first video frame is corresponding to one of the at least one second party;
identifying, at the communication device, an outline of a user in the first video frame;
cropping, at the communication device, a part of the each video frame outside the outline of the user to generate at least one second video frame;
obtaining, at the communication device, a third video frame of the local party through a camera;
combining, at the communication device, the at least one second video frame with the third video frame to generate a fourth video frame; and
displaying, at the communication device, the fourth video frame.

10. The method according to claim 9, further comprising:
transmitting, from the communication device, the fourth video frame to the at least one communicating party.

11. The method according to claim 9, wherein the identification of the outline of the user in the first video frame based on boundary point identification.

12. The method according to claim 9, wherein the third video frame includes only images inside an outline of a user in the third video frame.

13. A communication device, comprising:
a storage unit configured to store instructions; and
a processor configured to execute instructions to cause the processor to:
receive a first video frame of a communicating party which is in a communication with the communication device;
obtain a second video frame of the local party through a camera;
identify an outline of a user in the second video frame;
crop a part of the second video frame beside the outline of the user to generate a third video frame which includes only images inside the outline of the user;
combine the third video frame with the first video frame of the communicating party to generate a fourth video frame; and
display the fourth video frame.

14. The communication device according to claim 13, wherein the instructions further cause the processor to:
obtain a fifth video frame of the local party through an infrared imaging device;
identify an outline of a user in the fifth video frame;
determine a position where the outline of the user in the fifth video frame; and
identify an outline of a user in the second video frame based on the position where the outline of the user in the fifth video frame and a relationship between the camera and the infrared imaging device.

15. The communication device according to claim 13, wherein the instructions further cause the processor to:
transmit the fourth video frame to the second party.

16. The communication device according to claim 13, wherein the communication device is a fixed phone or a mobile phone.

17. The communication device according to claim 13, wherein the communication device is an electronic device which includes a communication unit.

18. The communication device according to claim 17, wherein the communication unit includes an instant message system.

19. The communication device according to claim 17, wherein the electronic device is a computer or a television.

20. The communication device according to claim 13, wherein the instructions further cause the processor to:
determine a corrected outline of the user by boundary point identification.
